(19) United States
(12) Patent Application Publication
(10) Pub. No.: US 2014/0255556 A1
(43) Pub. Date: Sep. 11, 2014

(54) SHELF-STABLE SNACK AND METHOD FOR MAKING SAME

(71) Applicant: FRITO-LAY NORTH AMERICA, INC., Plano, TX (US)

(72) Inventors: Ashish ANAND, Plano, TX (US); Kiran ANNAPRAGADA, Plano, TX (US); Vamshidhar PUPPALA, McKinney, TX (US); Ngoc TRINH, Dallas, TX (US); Chad WOELFLE, Plano, TX (US)

(73) Assignee: FRITO-LAY NORTH AMERICA, INC., Plano, TX (US)

(21) Appl. No.: 13/785,929

(22) Filed: Mar. 5, 2013

(51) Int. Cl. A21D 13/00

(52) U.S. Cl. CPC A21D 13/0067
USPC 426/94; 426/302; 118/20

(57) ABSTRACT

A shelf-stable snack and method for making the same. First a dough is mixed and sheeted to form a sheeted dough. Thereafter, the sheeted dough is cut to form at least one dough piece. Sauce is sprayed upon the dough piece with a textural sprayer. The dough has a moisture content of between about 30 and about 45% by weight and has an average particle size of between 100-500 microns. Then the dough piece is dried to a moisture content of less than 3%.

### BACKGROUND OF THE INVENTION

1. Technical Field

The present invention relates to a shelf-stable snack and a method for making the same.

2. Description of Related Art

Shelf-stable snacks are very popular with consumers. Due to the ease of storage, many consumers desire a wide variety of shelf-stable snacks. While there are a variety of flavors, the shelf-stable snacks fail to mimic other popular food items. Consequently, it is desirable to manufacture a shelf-stable snack which mimics other popular food items.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a process flow chart of a method of making a shelf-stable snack in one embodiment.

FIG. 2 is a perspective view of spray nozzles and a nozzle base in one embodiment.

### DETAILED DESCRIPTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

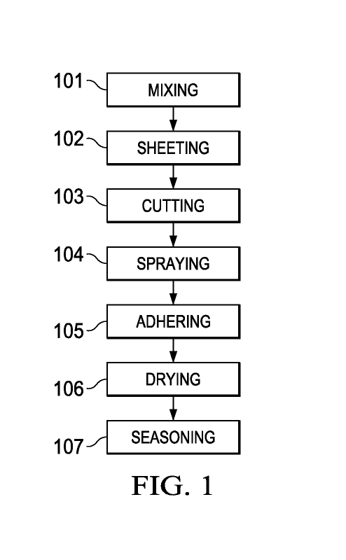

FIG. 1 is a flow chart of a method of making a shelf-stable snack product in one embodiment. A shelf-stable snack product, as used herein, is a product which, when packaged, does not require refrigeration and is stable at typical ambient conditions for at least one month. In one embodiment, the product is shelf-stable for at least 6 months. A shelf-stable product is microbiologically safe and does not show significant organoleptic differences between the aged product and the fresh product. Shelf-stable products are convenient for a variety of reasons. First, shelf-stable products, compared to short shelf-life products, provide increased flexibility in supplying the product to retail stores. Second, retailers appreciate shelf-stable product because this product provides the retailer a longer opportunity to sell the product. Finally, consumers appreciate the product because they know they do not have to consumer the product quickly. Thus, in many situations a shelf-stable product is beneficial.

Many different types of shelf-stable snack products can be manufactured using the methods described herein. These include, but are not limited to, shelf-stable pizza snacks, manakeesh, and flatbread snacks. One embodiment will be described in reference to a shelf-stable pizza snack but the method described is not so limited.

In the embodiment depicted in FIG. 1, the first step is mixing 101 ingredients to form a base dough. The dough, in one embodiment, will form the flatbread base upon which sauce and/or additional toppings will be applied. Various ingredients can be mixed to form a dough. In one embodiment the dough comprises wheat and/or other cereal flours. Applicants have discovered that wheat flour allows the final product to be crispy without being undesirably hard and tough. A base dough which comprises a high amount of protein results in a hard and tough final product. Wheat flour, when hydrated, produces a dough with unique rheological properties which enable the retention of leavening gases such as carbon dioxide and water vapor during baking This results in an expanded, foamy structure and chewy texture.

There are different types of wheat flour classified according to their growing seasons such as spring or winter, kernel color such as red or white, and texture such as hard or soft. Texture or hardness is primarily determined by protein content. Generally, low protein wheat flours, such as soft wheat, result in a softer texture whereas high protein flours, such as hard wheat, produce stronger and harder texture in food products. Low protein wheat is a wheat which has a protein of 11% or less. High protein wheat is a wheat which has a protein greater than 11% by weight. Applicants have discovered that customizing and adjusting the combination of wheat flours and thus protein content has provided a greater level of control in the properties of the final product. Thus, in one embodiment the wheat flour comprises a combination of high protein and low protein wheat flours to deliver a desired texture in a flatbread snack product. In one embodiment wheat flour with about 6 to about 10% protein is used to produce a flatbread with soft texture, whereas in another embodiment wheat flour with about 12 to about 14% protein content is used to produce a harder textured flatbread. In yet another embodiment a specific blend of the low protein, soft wheat flour, and high protein, hard wheat flour, in a ratio between about 20:80 and 80:20 is used to achieve desired product texture. In another embodiment a ratio of about 60:40 is utilized.

Wheat and other cereal flours can comprise between 50% to about 85% of the dough by weight. In one embodiment the wheat and other cereal flours comprise about 75% of the formulation.

Other ingredients can also be added to the dough. The type and amount of flour is dependent on the desired final product. In one embodiment the dough comprises starches and starch rich ingredients. Starches can be used to control texture. Pregelatinized and/or native starches can be used to enhance sheeting performance of the dough as well as assist in shape integrity. Starches also enhance the finished product integrity by reducing breakage. Pregelatinized starches can vary in their amylose-amylopectin contents and can include starches from a wide range of sources. Sources include, but are not limited to, corn, tapioca flour, sorghum, rice, and any cereal starch. In one embodiment wherein the appropriate cooking conditions, such as moisture, time and temperature, are lacking to gelatinize the starch, pregelatinized starches are used. The amount of starches can vary depending on the desired properties of the flatbread. In one embodiment the amount of starches in the dough ranges from 0% to about 35%, whereas in other embodiments the starches comprise about 15% to about 30% of the dough. In still other embodiments, the starches comprise about 25% of the dough formulation by weight.

As noted above, the amount of protein in the dough affects the hardness of the final flatbread. Protein can be added with wheat and cereal flours as discussed above. In one embodiment the dough further comprises protein ingredients. Protein ingredients comprise ingredients other than wheat and cereal flours which comprise protein. Examples of protein ingredients include but are not limited to milk powder, vital wheat gluten, soy protein, egg protein, cereal proteins. Network forming proteins, such as wheat gluten, can enhance a sheeting performance of a dough by improving cohesion and structural strength of the dough. Further, such proteins also improve final product texture and integrity by reducing breakage. Finally, the addition of protein ingredients also increases the amount of protein in the final product, increasing the nutritional value of the product.

The amount of protein ingredients added can vary from 0% to about 25% of the dough by weight. In one embodiment protein ingredients comprises between about 10% and 20%, whereas in another embodiment protein comprises about 15% of the dough formulation by weight.

In one embodiment the dough further comprises flavor ingredients. Flavor ingredients, as used herein, are ingredients which are added primarily for flavor and include, but are not limited to, spices, extracts, vegetables, and fruits added primarily for taste. Examples of a flavor ingredient include onions including dried, fresh, flakes, granules, and powder, and garlic including dried or fresh, flakes, granules, and powder. Other examples of flavor ingredients include aromatic herbs such as rosemary, thyme, basil, oregano, marjoram, sage, and cilantro, and spices such as garlic, ginger, cumin, pepper, etc. The flavor ingredients can further comprise extracts such as almonds, anise, citrus, and hazelnut. As noted, the flavor ingredients can also include vegetable or fruit inclusions including peppers, tomatoes, eggplant, etc. Finally, the flavor ingredients can include yogurt and milk powders. In one embodiment the flavor ingredients comprise between 0% to about 15% of the dough by weight, whereas in other embodiments the flavor ingredients comprise about 3% to about 8% of the dough. In still other embodiments, the flavor ingredients comprise about 5% of the dough by weight.

In one embodiment the dough further comprises leavening agents. Leavening agents are agents which are added to assist in leavening the dough. Examples include, but are not limited to, yeast, including compressed, dry active, and instant dry active, as well as baking soda and/or baking powder, and combinations thereof. In one embodiment the leavening agents comprise between 0% to about 15% of the dough by weight, whereas in other embodiments the leavening agents comprise about between about 3% to about 8% of the dough. In still other embodiments leaving agents comprise about 5% of the dough by weight.

The dough can further comprise salt. Salt can be added to help in taste and texture. Salt can be added between 0% and 5%, and in one embodiment between about 2% and about 4%. In another embodiment salt comprises about 3% of the dough formulation by weight.

Likewise, the dough can further comprise sugar, which can be added to assist in taste. Sugar can be added between 0% and 5%, and in one embodiment between about 2% and about 4%. In another embodiment sugar comprises about 3% of the dough formulation by weight.

The dough can further comprise fat ingredients such as butter, margarine, and/or vegetable oils. Fat ingredients add to the final taste as well as assist in processing. Fat ingredients can comprise between 5% to about 15% of the dough by weight. In one embodiment fat ingredients comprise about 10% of the dough by weight.

The dough can further comprise fiber ingredients such as cereal grains, oat fibers, and vegetable fibers. Fiber can be added between 0% and 10%, and in one embodiment between about 3% and about 8%. In another embodiment fiber ingredients comprises about 5% of the dough formulation by weight.

In one embodiment the moisture content of the dough is from about 20% to about 30% by weight. The moisture content of the dough is monitored to ensure a final desired moisture content is reached. If the moisture content of the dough is too high, the dough will require too much dehydration resulting in an inferior product.

After the dough is mixed, the dough is sheeted in a sheeting step 102. The dough can be sheeted in any known sheeter. The thickness of the sheeted dough can vary. Thickness, in this case, is measured in terms of weight of a piece of down of known area in grams per area. In one embodiment the dough is sheeted such that a 48 mm rough cut weighs between about 15 to about 20 grams.

After the sheeting step 102, the sheeted dough is then cut in a cutting step 103. The cutting step 103 cuts the sheeted dough into cut pieces. The cut pieces can comprise any shape including but not limited to rough, triangular, square, rectangular, and virtually any geometric shape. The cutting step 103 can be accomplished with any cutting device known in the art.

After the cutting step 103, the cut dough pieces are subject to a spraying step 104. During the spraying step 104, a sauce is added to one side of the cut dough pieces. A sauce is added for several purposes. First, the sauce adds flavor and texture to the final product. Second, the sauce makes the final product more resemble a pizza product. Third, the sauce adheres other optional ingredients such as cheese, which will be discussed in more detail below.

In one embodiment the sauce comprises liquid ingredients and solid ingredients. The solid ingredients comprise a solid form and can comprise upwards of 50% of the sauce by weight. In one embodiment the solid ingredients comprise between about 20% to about 35% of the sauce by weight. Such solids content better resembles pizza sauce associated with traditional pizza products.

The solid ingredients can comprise any solid ingredient. The solid ingredients add texture and flavor to the sauce. Further, solid ingredients help the sauce mimic traditional pizza sauce. The solid ingredients can include tomato, garlic, onion, pepper, salt, cheese, paprika, and aromatic herbs such as rosemary, thyme, basil, oregano, marjoram, sage, sumac, cumin, cilantro, etc. Virtually any solid herb, spice, real or simulated vegetable or fruits can be utilized. In one embodiment the solid ingredients are added so that the sauce comprises an average particle size distribution of between about 100 and 500 microns.

As noted, the sauce further comprises liquid ingredients. The liquid ingredients comprise a liquid form and can comprise upwards of 95% of the sauce by weight. In one embodiment the liquid ingredients comprise between about 65% to about 80% of the sauce by weight.

The liquid ingredients can comprise oil, water, milk, or virtually any liquid. Oil can be used to replace water, thus improving throughput without diminishing process ability while increasing flavor and mouth feel in the finished product.

The liquid content of the sauce affects the viscosity of the sauce which affects pumping, spraying, application rate, etc. A higher liquids content with a lower solids content results in a lower viscosity which aids in optimum processing. However, optimum flavor often demands lower liquids content and higher solids content. Thus, processing and flavoring are often at odds, and a balance must be stricken between the two.

The sauce can further comprise a thickener which is used to control the viscosity of the sauce. Suitable examples of thickeners include pregelatinized starch, cereals, tubers, legume flours, and fiber. The amount of thickener added, if any, can vary and in one embodiment ranges from 0% to about 5%. In one embodiment the sauce comprises a viscosity of between about 0.9 and about 5.0 Pascal-sec at 22° C.

The moisture content of the sauce can vary. In one embodiment the moisture content of the sauce ranges from about 30 to about 45%. A higher moisture content is problematic because the final product comprises a moisture content of less than 3% by weight to be shelf-stable. If the moisture content of the sauce is too high, then it is difficult to reach the final lower moisture content within the constraints of commercial baking operations as higher moisture sauce applications lead to lower drying efficiencies, lower capacities, and thus lower throughput. Thus, the moisture content of the sauce is controlled.

One way to reduce the moisture content of the sauce is to increase the solids of the sauce. However, this has proven difficult or impossible in the prior art due to the application of the sauce. Sauce or oil is often sprayed onto dough. These prior art sprayers use nozzles which results in a fine mist. Such nozzles are easily plugged and consequently, higher solids contents are avoided. To overcome this problem, in one embodiment, the sauce is applied with a textural sprayer. A textural sprayer is a sprayer which allow for higher solids content and large particle sizes compared to prior art sprayers. In one embodiment, the textural sprayer can tolerate a sauce with greater than 20% solids content, and an average particle size of between 100-500 microns without becoming plugged. In one embodiment average particle sizes of 1,000 microns or more can be used in a textural sprayer without plugging provided that an increased diameter is utilized as discussed below. A textural sprayer allows delivery of a suitable sauce and provides for efficient coverage of the dough.

Different nozzles can be utilized to control the rate of application, the size of the application, the resulting thickness of the sauce layer applied, etc. The nozzle diameter, flow rates, and nozzle geometry can all be adjusted to control sauce flow. A nozzle opening is similar to a thumb over a water hose; if the opening is too big there is not enough of a pressure drop to cause a wide spray pattern. Conversely, if the opening is too small the pressure drop is too great and the nozzle can be plugged. Thus, there is a spectrum of acceptable nozzle diameters which are dependent upon flow rate, thickness of the sauce, size of the solids in the sauce, etc.

The sauce is applied to the dough during the spraying step 104. As noted, in one embodiment the sauce is spray applied with a textural sprayer. The dough is conveyed below the textural sprayer, and the sauce is applied. Sauce which does not adhere to the dough is collected and re-used.

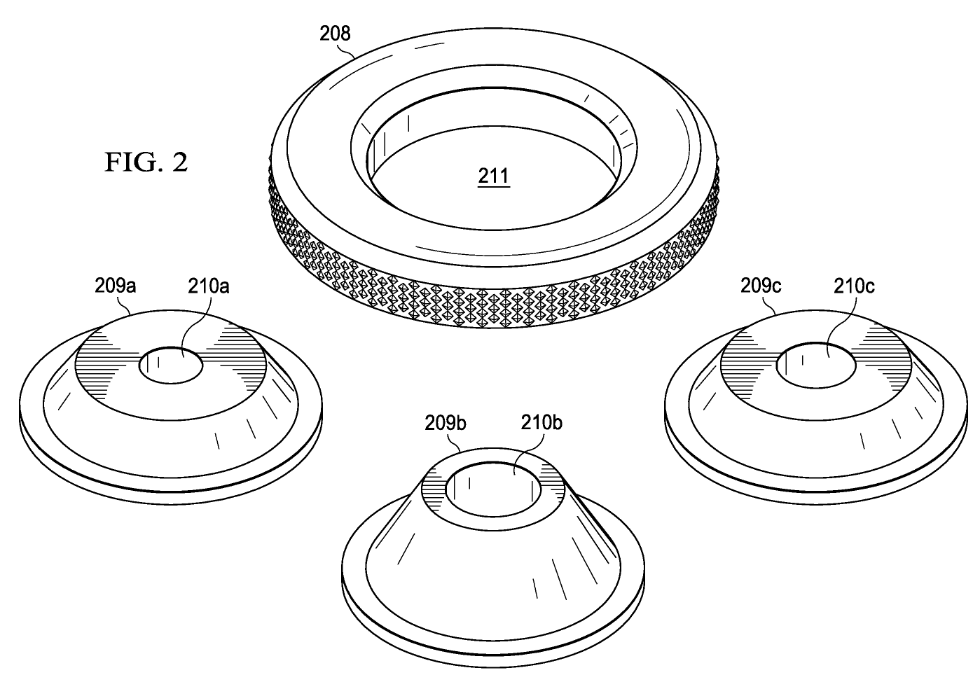

FIG. 2 is a perspective view of spray nozzles and a nozzle base in one embodiment. As depicted there are three nozzles 209a, 209b, 209c. Each of these nozzles has a varying diameter 210a, 210b, 210c. As noted, the diameter can be optimally selected depending upon the desired flow rate, spray pattern, thickness of the sauce, and the size of the solids in the sauce. In one embodiment, the diameters range from about 3/16 to about 5/16 of an inch. In one embodiment the diameter is ¼ of an inch, whereas in other embodiments the diameter is about 3/16 of an inch. A nozzle with a diameter of 3/16 of an inch results in atomization of the sauce which adds less topical moisture. Such diameters allow sauce with an average particle size distribution of between about 100 and 500 microns to be sprayed without plugging the nozzles. As noted, an average particle distribution of 1,000 microns or larger can be utilized on a textural sprayer if the textural sprayer has an increased diameter. An increased diameter will result in more sauce being applied which can result in potential moisture problems downstream.

The flow rate through the nozzles can vary depending on the line throughput. In one embodiment the flow rate ranges from about 50 to about 450 pounds per hour of sauce. In one embodiment the pressure drop at the nozzle ranges from about 20 to about 100 psi and has a nozzle velocity of about 10 to about 55 meters per second. In another embodiment the pressure drop ranges from about 10 to about 150 psi. In yet another embodiment the nozzle velocity is about 30 to about 70 meters per second.

Returning back to FIG. 2, FIG. 2 also depicts a nozzle base 208. The nozzle base is affixed, via screwing or other affixing devices, to the sprayer. The nozzles 209a-c fit within the cavity 211 of the nozzle base 208.

In one embodiment a single nozzle 209 is used to spray the sauce. However, in other embodiments two or more nozzles 209 are used to apply the sauce. In one such embodiment two or more nozzles 209 are arranged to spray sauce onto the below conveyor. In one embodiment, the two or more nozzles 209 are aligned in parallel such that a single feed supplies sauce to each nozzle 209. The number, spacing, and arrangement of the nozzles 209 is dependent upon the width of the conveyor, the speed of the conveyor, and the arrangement of product upon the conveyor.

After the spraying step 104 is an optional adhering step 105. During the adhering step 105 additional toppings are applied atop the sauce. The additional toppings can include virtually any type of food toppings including real and artificial vegetable pieces, seeds such as sesame or sunflower, cheese, starches, and other particulates. The toppings can be added to affect flavor and nutritional value. Further, the toppings can be added to make the final product more resemble a traditional pizza.

The toppings can be applied with any device or any method known in the art. The sauce previously applied helps adhere the toppings to the dough piece.

After adhering the toppings in the adhering step 105, there is the drying step 106. As previously noted, in one embodiment the snack is dried to a moisture content of below about 3%. This can be accomplished with any drying devices known in the art including ovens, microwaves, etc. In one embodiment the snack is baked in a first oven to a moisture content of 6-8%. Thereafter, the product is finish dried in either a different oven or a microwave to a moisture content of about 2%.

After the drying step 106 is an optional seasoning step 107. In the seasoning step 107 seasoning such as salt, sugar, and other seasonings can be applied to the dried product to make a final product. Seasoning can be applied with any device or method known in the art. In one embodiment an optional topical oil spray can be applied prior to or simultaneous with the seasoning step 107 to help the seasoning adhere to the product.

While a method has been described, a system for utilizing the method is described below. The system can comprise a cutter and a sheeter to cut and sheet the dough. The system also comprises a conveyor used to transport the dough pieces. In one embodiment the conveyor conveys cut pieces below a textural sprayer. In one embodiment the conveyor comprises a collecting device adjacent to and/or below the conveyor to collect sauce which does not adhere to the dough pieces. In one embodiment said the unused sauce is collected for reapplication. The conveyor can comprise any conveyor known in the art and in one embodiment comprises a linked wire conveyor. The conveyor is coupled to a drying device which can include any drying device, including but not limited to an oven, a convection oven, a microwave oven, and combinations thereof. In one embodiment the product is first dried in a first drying device and then is conveyed to a different second drying device for further drying.

For example, in one embodiment the first drying device comprises an oven whereas the second drying device comprises a microwave.

In one embodiment the textural sprayer located above said conveyor. The textural sprayer comprises at least one nozzle, and in one embodiment the nozzle has a diameter between about 3/16 and 5/16 of an inch. In one embodiment the textural sprayer comprises at least two nozzles connected in parallel.

Various examples are provided below. These examples are provided for illustrative purposes and should not be limited.

Pizza Example

As noted, in one embodiment the final product resembles a pizza snack. The pizza sauce comprises tomato powder, salt, canola oil, basil, pepper, onion powder, garlic powder, cheese powder, and milk powder. The sauce is mixed and applied to a cut and sheeted flatbread dough. The sauce is applied via a textural sprayer. In one embodiment, sauce is added in an amount to comprise about 5 to about 35% of the total solids content of the finished product. In one embodiment sauce is added in an amount to comprise up to 30% of the total solids content of the finished product. Thereafter additional toppings are added to the sauce covered dough piece. In one embodiment, solid toppings are added in an amount to comprise about 5 to about 35% of the total solids content of the finished product. In one embodiment additional toppings are added in an amount to comprise up to 30% of the total solids content of the finished product. Thereafter, the product is baked to a moisture content of less than about 3%.

Manakeesh

Another type of snack which can be made includes Manakeesh. First a flatbread dough is mixed, sheeted, and cut. Thereafter, the cut dough is sprayed with a sauce. In this embodiment the sauce comprises oil, water, pepper, tomato powder, Zaatar, and water. The sauce is applied with a textural sprayer. Sauce is added in an amount to comprise about 5 to about 35% of the total solids content of the finished product. In one embodiment sauce is added in an amount to comprise up to 30% of the total solids content of the finished product. Thereafter solid toppings are added to the sauce covered dough piece. The solid toppings can comprise any solid topping discussed herein, but in one embodiment the solid toppings comprise sesame seeds. In one embodiment, solid toppings are added in an amount to comprise 4 to about 35% of the total solids content of the finished product. In one embodiment solid toppings are added in an amount to comprise up to 30% of the total solids content of the finished product. The product is baked to a moisture content of less than about 3%.

While the invention has been particularly shown and described with reference to a preferred embodiment, it will be understood by those skilled in the art that various changes in form and detail may be made therein without departing from the spirit and scope of the invention.

### Additional Description

The following clauses are offered as further description of the disclosed invention.
1. A method for making a shelf stable snack, said method comprising:
   a. sheeting a dough to form a sheeted dough;
   b. cutting said sheeted dough to form at least one dough piece;
   c. spraying sauce on said dough piece, wherein said sauce comprises a moisture content of between about 30 and about 45% by weight, wherein said sauce comprises an average particle size of 100-500 microns, and wherein said spraying comprises spraying with a textural sprayer; and
   d. drying said dough piece to a moisture content of less than 3% to form a dried piece.
2. The method according to any preceding clause wherein said sauce comprises a viscosity of between about 0.9 and about 5.0 Pascal-sec at 22° C.
3. The method according to any preceding clause wherein said sauce comprises a solids content greater than 20%.
4. The method according to any preceding clause wherein said sauce comprises a solids content between about 55 and 70%.
5. The method according to any preceding clause wherein said sauce comprises a solids content greater than 50%.
6. The method according to any preceding clause wherein said sauce comprises a liquid content between about 65% and 80% of the sauce by weight.
7. The method according to any preceding clause wherein said method further comprises the step of adhering additional toppings to said dough piece after said spraying step and before said drying step.
8. The method according to clause 7 wherein said additional toppings are added so as to comprise between about 5% to about 35% of the total solids content in the dried piece.
9. The method according to any preceding clause wherein said dough comprises a moisture content of between about 20% and about 30% by weight.
10. The method according to any preceding clause wherein said sauce of said spraying step is applied at about 5% to about 25% of the dough piece by weight.
11. The method according to any preceding clause wherein said spraying comprises a flow rate between about 50 and about 450 pounds per hour.
12. The method according to any preceding clause wherein said sauce comprises about 5% to about 35% of the total solids content in the dried piece.
13. The method according to any preceding clause wherein said sprayer comprises a nozzle.
14. The method according to clause 13 wherein said nozzle comprises a diameter between about 3/16 and 5/16 of an inch.
15. The method according to clause 13 wherein said nozzle results in a pressure drop of between about 20 and 100 psi.
16. The method according to any preceding clause wherein said dough comprises 50-85% wheat flours by weight.
17. The method according to any preceding clause wherein said dough comprises low protein wheat and high protein wheat, and wherein the ratio of low protein to high protein wheat is between about 20:80 and about 80:20.
18. The method according to any preceding clause wherein said spraying results in a nozzle velocity between about 10 and 55 meters per second.
19. A shelf-stable snack made from the process according to clause 1.
20. A system for making a shelf stable snack, said system comprising:
   a conveyor coupled to a first drying device;
   a textural sprayer located above said conveyor, wherein said textural sprayer comprises at least one nozzle, wherein said nozzle comprises a diameter between about 3/16 and 5/16 of an inch.
21. The system according to clause 20 wherein textural sprayer is capable of applying a sauce comprising an average particle size between about 100 and 500 microns.
22. The system according to clauses 20-21 wherein at least two nozzles are connected in parallel.
23. The system according to clauses 20-22 further comprising a second drying device, wherein said second drying device is different from said first drying device.

What is claimed is:

1. A method for making a shelf stable snack, said method comprising:
a. sheeting a dough to form a sheeted dough;
b. cutting said sheeted dough to form at least one dough piece;
c. spraying sauce on said dough piece, wherein said sauce comprises a moisture content of between about 30 and about 45% by weight, wherein said sauce comprises an average particle size of 100-500 microns, and wherein said spraying comprises spraying with a textural sprayer; and
d. drying said dough piece to a moisture content of less than 3% to form a dried piece.

2. The method of claim 1 wherein said sauce comprises a viscosity of between about 0.9 and about 5.0 Pascal-sec at 22° C.

3. The method of claim 1 wherein said sauce comprises a solids content greater than 20%.

4. The method of claim 1 wherein said sauce comprises a solids content between about 55 and 70%.

5. The method of claim 1 wherein said sauce comprises a solids content greater than 50%.

6. The method of claim 1 wherein said sauce comprises a liquid content between about 65% and 80% of the sauce by weight.

7. The method of claim 1 wherein said method further comprises the step of adhering additional toppings to said dough piece after said spraying step and before said drying step.

8. The method of claim 7 wherein said additional toppings are added so as to comprise between about 5% to about 35% of the total solids content in the dried piece.

9. The method of claim 1 wherein said dough comprises a moisture content of between about 20% and about 30% by weight.

10. The method of claim 1 wherein said sauce of said spraying step is applied at about 5% to about 25% of the dough piece by weight.

11. The method of claim 1 wherein said spraying comprises a flow rate between about 50 and about 450 pounds per hour.

12. The method of claim 1 wherein said sauce comprises about 5% to about 35% of the total solids content in the dried piece.

13. The method of claim 1 wherein said sprayer comprises a nozzle.

14. The method of claim 13 wherein said nozzle comprises a diameter between about 3/16 and 5/16 of an inch.

15. The method of claim 13 wherein said nozzle results in a pressure drop of between about 20 and 100 psi.

16. The method of claim 1 wherein said dough comprises 50-85% wheat flours by weight.

17. The method of claim 1 wherein said dough comprises low protein wheat and high protein wheat, and wherein the ratio of low protein to high protein wheat is between about 20:80 and about 80:20.

18. The method of claim 1 wherein said spraying results in a nozzle velocity between about 10 and 55 meters per second.

19. A shelf-stable snack made from the process of claim 1.

20. A system for making a shelf stable snack, said system comprising:
a conveyor coupled to a first drying device;
a textural sprayer located above said conveyor, wherein said textural sprayer comprises at least one nozzle, wherein said nozzle comprises a diameter between about 3/16 and 5/16 of an inch.

21. The system of claim 20 wherein textural sprayer is capable of applying a sauce comprising an average particle size between about 100 and 500 microns.

22. The system of claim 20 wherein at least two nozzles are connected in parallel.

23. The system of claim 20 further comprising a second drying device, wherein said second drying device is different from said first drying device.
